(19) United States
(12) Patent Application Publication
(10) Pub. No.: US 2014/0027452 A1
(43) Pub. Date: Jan. 30, 2014

(54) Trash Can With A Deodorization and Sterilization Function

(71) Applicant: Tu-Cheng Pan, Taichung City (TW)

(72) Inventor: Tu-Cheng Pan, Taichung City (TW)

(21) Appl. No.: 13/557,626

(22) Filed: Jul. 25, 2012

(51) Int. Cl. B65F 7/00; B65F 1/14

(52) U.S. Cl. 220/87.2

(57) ABSTRACT

A trash can with the deodorization and sterilization function contains a body with the cover and an ozone generator fixed in the body. The ozone generator is fixed at a predetermined position of the cover of the body and is in connection with a controlling member. The controlling member is mounted at a position of an inner surface of the cover adjacent to the body and couples with the ozone generator and a wire for electrically connecting with a power source, such that when the cover covers the body of the trash can, it triggers the controlling member by which the ozone generator is started to produce the ozone in the body, hence the odor from the litters is eliminated, and the bacteria are disinfected.

### FIELD OF THE INVENTION

The present invention relates to a trash can with a deodorization and sterilization function which when a cover covers a body of the trash can, ozone is produced in the body to eliminate the odor from the litter and to disinfect the bacteria.

### BACKGROUND OF THE INVENTION

A conventional trash can includes a cover to be opened by the user to throw litter therein, and then the cover is covered on the trash can, thereby preventing odor from leaking. However, the litter generates odor and produces bacteria in the closed trash can after a period of time. The odor will spread when the cover of the trash can is opened.

The present invention has arisen to mitigate and/or obviate the afore-described disadvantages.

### SUMMARY OF THE INVENTION

The primary object of the present invention is to provide a trash can with a deodorization and sterilization function which when a cover covers a body of the trash can, ozone produces in the body to eliminate the odor from the litter and to disinfect the bacteria.

To obtain the above objective, a trash can with a deodorization and sterilization function provided by the present invention contains:

a body with the cover and an ozone generator fixed in the body, wherein the ozone generator is fixed at a predetermined position of the cover of the body and is in connection with a controlling member;

the controlling member is mounted at a position of an inner surface of the cover adjacent to the body and couples with the ozone generator and a wire for electrically connecting with a power source, such that when the cover covers the body of the trash can, it triggers the controlling member by which the ozone generator is started to produce the ozone in the body, hence the odor from the litters is eliminated, and the bacteria are disinfected;

wherein the ozone generator is fixed on an inner surface of the cover;

wherein a controlling member is mounted at a position of the inner surface of the cover adjacent to the body and couples with the ozone generator and a wire for electrically connecting with a power source, such that when the cover covers the body, it triggers the controlling member by which the ozone generator is started to produce the ozone in the body;

wherein the controlling member is a micro switch or a sensor switch.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view showing the assembly of a trash can with a deodorization and sterilization function according to a preferred embodiment of the present invention.

FIG. 2 is another perspective view showing the assembly of the trash can with the deodorization and sterilization function according to the preferred embodiment of the present invention.

FIG. 3 is a cross sectional view showing the assembly of the trash can with the deodorization and sterilization function according to the preferred embodiment of the present invention.

FIG. 4 is a cross sectional view showing the operation of the trash can with the deodorization and sterilization function according to the preferred embodiment of the present invention.

### DETAILED DESCRIPTION OF THE PREFERRED EMBODIMENTS

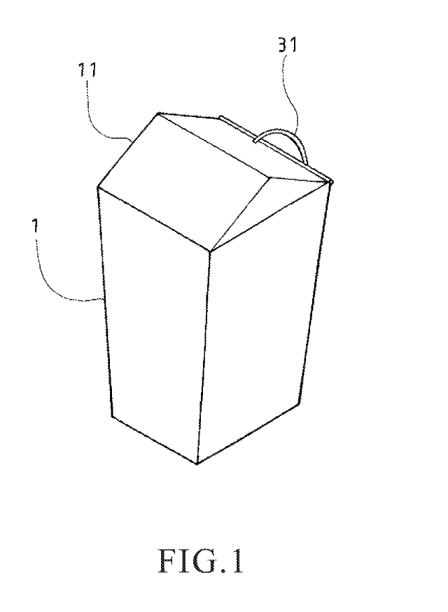

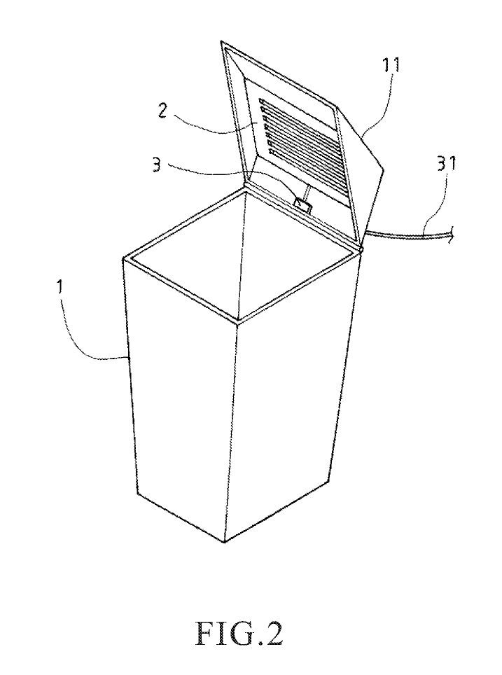

FIGS. 1 and 2 are a perspective view showing the assembly of a trash can with a deodorization and sterilization function according to a preferred embodiment of the present invention. The trash can with the deodorization and sterilization function comprises a body 1 and an ozone generator 2 disposed in the body 1. The body 1 has a rotatable cover 11 axially connected on one side of an opening of a top end thereof so that as the cover 11 covers the opening of the body 1, the body 1 becomes a closed receiving space in its interior. The ozone generator 2 is fixed at a predetermined position of an inner surface of the cover 11 (It is preferable that the ozone generator 2 allows to be fixed at other positions of the body 1), and a controlling member 3 is mounted at a position of the inner surface of the cover 11 adjacent to the body 1 and couples with the ozone generator 2 and a wire 31 for electrically connecting with a power source. In this embodiment, the controlling member 3 is a micro switch or a sensor switch.

In operation, the cover 11 is moved downwardly to cover the body 1 and to trigger the controlling member 3, and then the controlling member 3 starts the ozone generator 2 to produce ozone in the closed receiving space of the body 1 to eliminate odor of litters and to sterilize bacteria.

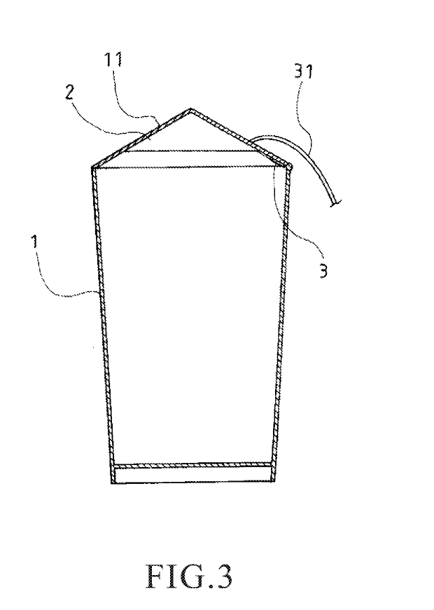

FIG. 3 is a cross sectional view showing the assembly of the trash can with the deodorization and sterilization function according to the preferred embodiment of the present invention. With reference to FIGS. 2 and 3, the ozone generator 2 is secured on the inner surface of the cover 11 of the body 1 so that as the cover 11 covers the body 1, the ozone generator 2 moves downwardly, and the controlling member 3 is mounted at the position of the cover 11 adjacent to the body 1 and is in connection with the ozone generator 2 and the wire 31, such that as the cover 11 covers the body 1 after the wire 31 electrically connects with a power outlet (or a battery) of mains electricity, the cover 11 triggers the controlling member 3 (in a contacting or a sensing manner), thereafter the controlling member 3 starts the ozone generator 2 to produce ozone in the body 1 of the trash can.

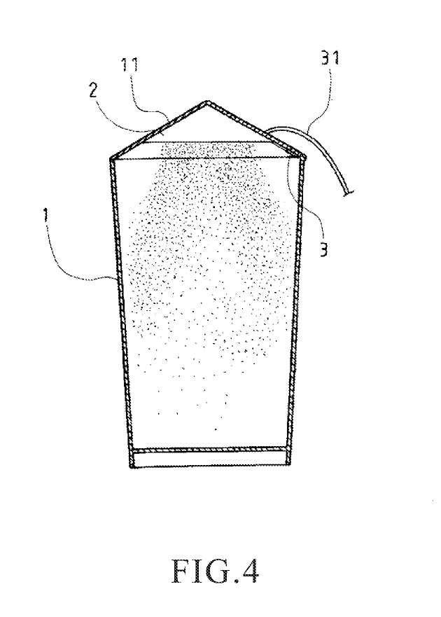

FIG. 4 is a cross sectional view showing the operation of the trash can with the deodorization and sterilization function according to the preferred embodiment of the present invention. In operation, the cover 11 of the body 1 is opened upwardly to throw the litter into the body 1 of the trash can, at this moment, the controlling member 3 is not triggered and the ozone generator 2 will not operate. When the cover 11 covers the body 1 of the trash can, the controlling member 3 is triggered to drive the ozone generator 2 to produce the ozone in the body 1, thus eliminating odor and sterilizing bacteria. Preferably, the controlling member allows being set a predetermined operating time by a user so that the ozone generator 2 stops a supply of the ozone in the body 1 after a period of operation time, thus saving power.

Thereby, the trash can with the deodorization and sterilization function of the present invention contains the body 1 with the cover 11 and the ozone generator 2 fixed in the body 1. The ozone generator 2 is at the predetermined position of the cover 11 of the body 1 and is in connection with the controlling member 3, the controlling member 3 couples with the wire 31 for electrically connecting with the power source, such that when the cover 11 covers the body 1 of the trash can, it triggers the controlling member 3 by which the ozone generator 2 is started to produce the ozone in the body 1, hence the odor from the litters is eliminated, and the bacteria are disinfected.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A trash can with a deodorization and sterilization function comprises:
a body having a rotatable cover axially connected thereon so that as the cover covers the body, the body becomes a closed receiving space;
an ozone generator disposed in the body to produce ozone in the body, thus eliminating odor and sterilizing bacteria.

2. The trash can with the deodorization and sterilization function as claimed in claim 1, wherein the ozone generator is fixed on an inner surface of the cover.

3. The trash can with the deodorization and sterilization function as claimed in claim 1, wherein a controlling member is mounted at a position of the inner surface of the cover adjacent to the body and couples with the ozone generator and a wire for electrically connecting with a power source, such that when the cover covers the body, it triggers the controlling member by which the ozone generator is started to produce the ozone in the body.

4. The trash can with the deodorization and sterilization function as claimed in claim 3, wherein the controlling member is a micro switch.

5. The trash can with the deodorization and sterilization function as claimed in claim 3, wherein the controlling member is a sensor switch.
